(19) United States
(12) Patent Application Publication
(10) Pub. No.: US 2016/0060077 A1
(43) Pub. Date: Mar. 3, 2016

(54) ELEVATOR

(71) Applicant: KONE Corporation, Helsinki (FI)

(72) Inventors: Markku HAAPANIEMI, Helsinki (FI); Matti RÄSÄNEN, Hyvinkaa (FI); Markku HÄIVÄLÄ, Hyvinkaa (FI); Janne MIKKONEN, Jarvenpaa (FI); Esko AULANKO, Kerava (FI)

(73) Assignee: KONE CORPORATION, Helsinki (FI)

(21) Appl. No.: 14/815,473

(22) Filed: Jul. 31, 2015

(30) Foreign Application Priority Data
Sep. 1, 2014 (EP) 14183022.4

(51) Int. Cl. B66B 7/06; B66B 11/08; B66B 15/04; B66B 9/00; B66B 15/02

(52) U.S. Cl. CPC B66B 7/062; B66B 9/00; B66B 15/02; B66B 15/04; B66B 11/08

(57) ABSTRACT

An elevator includes a hoistway; an elevator car vertically movable in the hoistway; a balancing weight vertically movable in the hoistway; a first roping including one or more belt-shaped first ropes interconnecting the elevator car and balancing weight, each of said one or more ropes passing around one or more first rope wheels mounted in proximity of the upper end of the hoistway, each of said one or more first ropes including one or more load-bearing members, each of which load-bearing members being made of composite material including reinforcing fibers embedded in a polymer matrix; a second roping including one or more toothed belt-shaped second ropes interconnecting the elevator car and balancing weight, each passing around one or more second rope wheels mounted in proximity of the lower end of the hoistway, each of said one or more second ropes including one or more load-bearing members, each of which load-bearing members being made of composite material including reinforcing fibers embedded in a polymer matrix; said one or more second rope wheels including a toothed drive wheel engaging said one or more toothed belt-shaped second ropes; and a motor for rotating the drive wheel.

### FIELD OF THE INVENTION

The invention relates to an elevator for transporting passengers and/or goods.

### BACKGROUND OF THE INVENTION

An elevator typically comprises an elevator car and a balancing weight, which are vertically movable in a hoistway. These elevator units are interconnected by a roping that suspends them on opposite sides of rope wheels mounted above the elevator units. For providing force for moving this suspension roping, and thereby also for the elevator units, one of the wheels is typically a drive wheel engaging the suspension roping, which drive wheel is rotated by motor.

Also such more uncommon elevators are known to exist where the elevator car and balancing weight are interconnected by a second roping in addition to said suspension roping, and where the force for moving the elevator units is provided by a drive wheel engaging the second roping instead of the suspension roping. This type of elevators are typically low-rise elevators, wherein the lifting height is usually less than 20 meters.

In hoisting function design, a challenge is that numerous of properties need to be taken into account simultaneously which properties are linked to each other. A problem with the elevators of the latter type has been that they have not been able to simultaneously provide adequately well the numerous important properties of the elevator. In particular, it has been difficult to obtain an elevator of a high lifting height while maintaining simplicity of the configuration, and energy efficiency, as well as force transmission ability (and thereby the lifting capacity) on excellent level.

### BRIEF DESCRIPTION OF THE INVENTION

The object of the invention is, inter alia, to alleviate previously described drawbacks of known elevators and problems discussed later in the description of the invention. The object of the invention is to introduce an elevator suitable for mid-rise or even high-rise solutions where simplicity of the configuration, and energy efficiency, as well as force transmission ability (and thereby the lifting capacity) are maintained on excellent level. Advantageous embodiments are presented, inter alia, which facilitate simplicity and energy-efficiency of the elevator as the moving components of the elevator can be made lightweighted, said components including at least the car and the ropings connected thereto. Advantageous embodiments are presented, inter alia, where the elevator is provided with first ropes optimized for the purpose of suspension, in particular in terms of ability to bear the car and balancing weight on opposite sides of said one or more first rope wheels, and where the elevator is provided with second ropes optimized for the purpose of transmitting motion control force, in particular in terms of ability to receive traction force from a drive wheel and transmitting it to the car and balancing weight.

It is brought forward a new elevator, which comprises a hoistway; an elevator car vertically movable in the hoistway; a balancing weight vertically movable in the hoistway; a first roping comprising one or more belt-shaped first ropes interconnecting the elevator car and balancing weight, each of said one or more ropes passing around one or more first rope wheels mounted in proximity of the upper end of the hoistway, each of said one or more first ropes comprising one or more load-bearing members (c), each of which load-bearing members being made of composite material comprising reinforcing fibers embedded in a polymer matrix. The elevator further comprises a second roping comprising one or more toothed belt-shaped second ropes interconnecting the elevator car and balancing weight, each passing around one or more second rope wheels mounted in proximity of the lower end of the hoistway, each of said one or more second ropes comprising one or more load-bearing members, each of which load-bearing members being made of composite material comprising reinforcing fibers embedded in a polymer matrix. Said one or more second rope wheels comprise a toothed drive wheel engaging said one or more toothed belt-shaped second ropes; and the elevator further comprises a motor for rotating the drive wheel. Hereby in the elevator the drive wheel is arranged to affect the second roping that does not primarily serve the function of suspending the car and balancing weight, and it positioned in proximity of the lower end of the hoistway instead of upper end, which is normally a must. This has an advantage that the elevator can be manufactured simple and easily maintainable. However, it provides also the advantage that the properties of the components of the hoisting function, particularly the properties of the first roping serving the suspension function and the properties of the second roping serving the function of force transmission for motion control, can be optimized separately to specifically suit best for the function they primarily serve. The ropes being of fiber reinforced composite material they are excellent in longitudinal stiffness and tensile strength with lightweighted structure. The elevator can thus be formed to have a high lifting height as problems concerning rope weight are eliminated in substantially all the ropings of the elevator. The positive engagement between the drive wheel and the second ropes is essential as in this way absolute traction is obtained without high rope tension, which is the case in context where said ropes which enable high lifting heights are used and the rope tension resulting from the particular arrangement of the drive wheel.

The elevator is particularly preferably such that on the first side of the drive wheel said one or more toothed belt-shaped second ropes are connected to the balancing weight hanging therefrom, and rotation of the drive wheel to first rotation direction is arranged to move said one or more toothed belt-shaped second ropes from said first side to second side for shortening the length of said one or more toothed belt-shaped second ropes on said first side, whereby the drive wheel is arranged to pull the balancing weight downwards via said one or more toothed belt-shaped second ropes when the drive wheel is rotated to said first rotation direction, and on the second side of the drive wheel said one or more toothed belt-shaped second ropes are connected to the car hanging therefrom, and rotation of the drive wheel to second rotation direction is arranged to move said one or more toothed belt-shaped second ropes from said second side to first side for shortening the length of said one or more toothed belt-shaped second ropes on said second side, whereby the drive wheel is arranged to pull the elevator car downwards via said second toothed belt-shaped ropes when the drive wheel is rotated to said second rotation direction.

The elevator is furthermore particularly preferably such that the first and second end of each first rope, as well as the first and second end of each second rope are fixed to the elevator car and the balancing weight, respectively.

Preferably, each of said one or more first ropes is engaged by the first wheels without positive engagement for force transmission between the first wheels and the first rope in longitudinal direction of the rope. Thereby, the rope structure, as well as the rope wheel structure are simple and easy to manufacture. Particularly, the rope structure can be formed extremely lightweighted as no large amount of coating is needed for forming the complex outer shape necessary for a positive engagement. Compared to fiber-reinforced composite material, coatings typically are relatively heavy and prone to form a great portion of the total weight of the rope. For this purpose, it is particularly preferably that each of said one or more belt-shaped first ropes is untoothed.

Preferably, each of said one or more belt-shaped first ropes has a uniform cross section throughout its length. Thereby, the rope structure is simple and easy to manufacture e.g. with a continuous process where coating is molded around load bearing members of the first ropes, for example by extrusion process.

Preferably, each of said one or more first rope wheels is non-driven, the first ropes passing around non-driven rope wheels only.

In one preferred implementation, each of said first rope(s) has at least one contoured side provided with guide rib(s) and guide groove(s) oriented in the longitudinal direction of the rope, said contoured side being fitted to pass against a contoured circumference of the one or more first rope wheels said circumference being provided with guide rib(s) and guide groove(s) so that said contoured circumference forms a counterpart for said contoured side(s) of the rope(s). Thus, the rope wheels provide the first ropes lateral guidance with simple rope structure and without positive engagement in longitudinal direction of the rope. In this way the elevator system presented, the structure and lateral guidance of the first ropes are optimized for the purpose of suspension. For facilitating easy manufacturing of the grooves, the first ropes have its load-bearing member(s) embedded in a coating made of elastomer and forming the outer surface of the rope and thereby also the contoured side. In an alternative preferred implementation, each of said first rope(s) has at least one smooth side fitted to pass against a cambered circumference of the one or more of the first rope wheels. Thus, the rope wheels provide the first ropes lateral guidance, but with even more simple construction of ropes.

Preferably, the load-bearing member(s) of each second rope is/are embedded in a coating made of elastomer and forming the outer surface of the rope and having a toothed shape thereby forming teeth of the toothed belt-shaped second rope. Likewise, it is preferable that the load-bearing member(s) of each first rope is/are embedded in a coating made of elastomer and forming the outer surface of the first rope.

Preferably, at least the toothed drive wheel, and preferably also all of said one or more first rope wheels, is mounted inside the lower end of the hoistway or inside a space beside or below the lower end of the hoistway.

Preferably, said one or more first rope wheels are mounted inside the upper end of the hoistway or inside a space beside or above the upper end of the hoistway.

Preferably, said reinforcing fibers of the first ropes are carbon fibers. Preferably, said reinforcing fibers of the second ropes are carbon fibers, but alternatively they can be some other fibers, such as nanocellulose fibers. In one preferred implementation said reinforcing fibers of the second ropes are same fibers than the reinforcing fibers of the first ropes. Then it is preferable, that said reinforcing fibers of the first ropes are carbon fibers, and said reinforcing fibers of the second ropes are also carbon fibers. In an alternative preferred implementation, said reinforcing fibers of the second ropes are different fibers than the reinforcing fibers of the first ropes. Then it is preferable, that said reinforcing fibers of the first ropes are carbon fibers, and said reinforcing fibers of the second ropes are nanocellulose fibers.

In one preferred implementation, the elevator comprises only the aforementioned ropings. In an alternative preferred implementation, there are two of each of the defined first roping, the defined first rope wheel, the defined balancing weight, the defined drive wheel rotatable with a motor, and the defined second roping. This provides several advantages and options for elevator design. An advantage is that the balancing weights can thus be smaller in size. With a small balancing weight it is the solution can be made more space-efficient, especially in both the width direction and the depth direction of the elevator hoistway. Yet another advantage is that by means of the arrangement according to the invention the rope arrangements and layouts of elevators can be diversified, which enables easier layout design. Another advantage is that owing to the smaller stresses the hoistway structures can be lighter and cheaper than in prior-art solutions. As typical, in the elevator, it is preferable that the balancing weight(s) and the car travel along guide rails. One advantage of several balancing weight is that the guide rail forces are divided between four guide rails, instead of two, in which case smaller and cheaper guide rails can be used. Yet another advantage is that the whole solution is, owing to its symmetry, easily convertible to suit different hoistway sizes, in which case finding solutions viable for production is easier.

Preferably, said load bearing member(s) is/are parallel with the longitudinal direction of the rope. Thereby, it/they provide excellent longitudinal stiffness for the rope in question. The reinforcing fibers are also preferably parallel with the longitudinal direction of the rope, which facilitates further the longitudinal stiffness of the rope.

The composite material is preferably such that the individual reinforcing fibers are parallel with the length direction of the rope. The fibers are thus substantially untwisted relative to each other. Thus, they provide excellent longitudinal stiffness for the rope. The individual reinforcing fibers are preferably distributed in the matrix substantially evenly, such that substantially all the individual reinforcing fibers of the load bearing member are bound to each other by the matrix m common to them all.

To reduce buckling of fibers and to facilitate a small bending radius of the rope, among other things, it is preferred that the polymer matrix is hard, and in particular non-elastomeric. The most preferred materials are epoxy resin, polyester, phenolic plastic or vinyl ester. The matrix of the load bearing member 40 is preferably such that the module of elasticity E of the polymer matrix is over 2 GPa, most preferably over 2.5 GPa, yet more preferably in the range 2.5-10 GPa, most preferably of all in the range 2.5-3.5 GPa. The structure is advantageous as hereby the service life of the rope can be extended.

Preferably, the fibers F of the composite load bearing members of the first and the second ropes are non-metallic fibers, particularly with density less than 4000 kg/m3 and tensile strength over 1500 N/mm2.

Preferably, the lifting height of the elevator is more than 50 meters, but it can be even more than 100 meters. This kind of lifting heights are enabled with the elevator as defined above, said preferred features each facilitating this goal even further.

The car is preferably arranged to serve two or more landings. The car preferably responds to calls from landing and/or destination commands from inside the car so as to serve persons on the landing(s) and/or inside the elevator car. Preferably, the car has an interior space suitable for receiving a passenger or passengers, and the car can be provided with a door for forming a closed interior space.

### BRIEF DESCRIPTION OF THE DRAWINGS

In the following, the present invention will be described in more detail by way of example and with reference to the attached drawings, in which

FIG. 1 illustrates schematically an elevator according to an embodiment of the invention as viewed from the side.

FIG. 2 illustrates schematically an elevator according to another embodiment of the invention as viewed from the side.

FIG. 3a illustrates schematically a cross sectional view of the second rope positioned against a drive wheel of FIG. 1 or 2.

FIG. 3b illustrates a cross-section A-A of FIG. 3a.

FIG. 3c illustrates a preferred surface pattern of the teeth of the toothed belt-shaped rope of FIGS. 3a to 3c.

FIG. 4 illustrates schematically a cross sectional view of the second rope positioned against a rope wheel of FIG. 1 or 2 according to an embodiment where the first rope is grooved.

FIG. 5 illustrates schematically a cross sectional view of the second rope positioned against a rope wheel of FIG. 1 or 2 according to an embodiment where the first rope surface via which it rests against a rope wheel is smooth.

FIG. 6 illustrates inside the circle a partial and enlarged cross-section of the load bearing member of FIGS. 3 to 5.

FIG. 7 illustrates alternative cross-sections for the first and second ropes.

### DETAILED DESCRIPTION

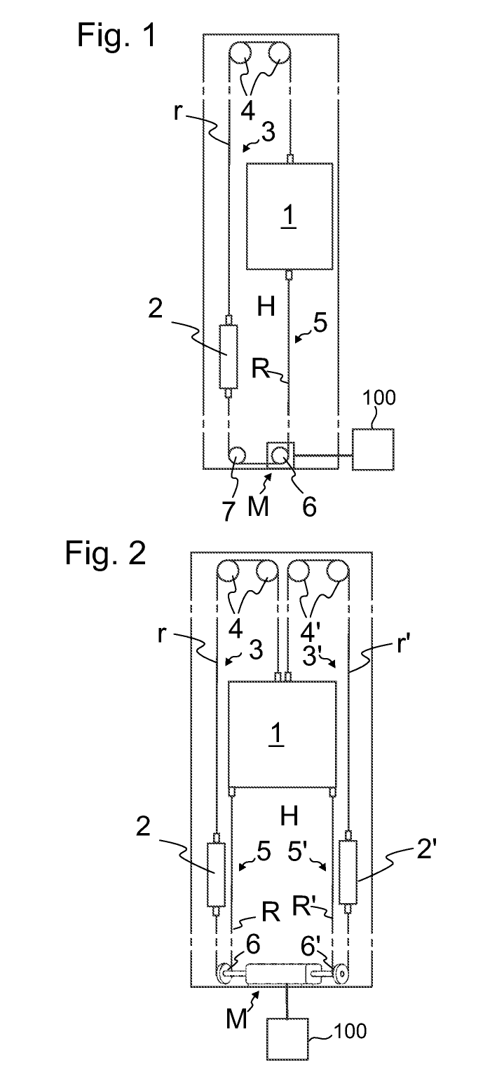

FIG. 1 illustrates an elevator, which comprises a hoistway H, an elevator car 1 vertically movable in the hoistway H, a balancing weight 2 vertically movable in the hoistway H, and a first roping 3 comprising one or more belt-shaped first ropes r interconnecting the elevator car 1 and balancing weight 2, each of said one or more ropes r passing around one or more first rope wheels 4 mounted in proximity of the upper end of the hoistway H, each of said one or more first ropes r comprising one or more load-bearing members c, each of the load bearing members c extending in longitudinal direction of the rope r throughout the length of the rope r, and each of the load-bearing members c being made of composite material comprising reinforcing fibers F embedded in a polymer matrix m. The elevator further comprises a second roping 5 comprising one or more toothed belt-shaped second ropes R interconnecting the elevator car 1 and balancing weight 2, each second rope R passing around one or more second rope wheels 6,7 mounted in proximity of the lower end of the hoistway H. Each of said one or more second ropes R comprising one or more load-bearing members C, each of the load bearing members C extending in longitudinal direction of the rope R throughout the length of the rope R, and each of the load-bearing members C being made of composite material comprising reinforcing fibers F embedded in a polymer matrix m. Said one or more second rope wheels (6,7) comprises a toothed drive wheel 6 engaging said one or more toothed belt-shaped second ropes R; and the elevator further comprises a motor M for rotating the drive wheel 6. The elevator further comprises an automatic elevator control 100 arranged to control the motor M, whereby rotation of the drive wheel 6 and thereby also the movement of the car 1 and balancing weight 2 is automatically controllable.

These first and second ropings 3,5 are separate from each other and pass around different rope wheels. The first ropes r serve as means for connecting the car and balancing weight to each other and for suspending these in the hoistway on opposite sides of said first rope wheels 4, which provide the ropes r upwards directed reaction force needed for the suspending effect. The second ropes R serve as means for transmitting downwards pulling force from the motor M to either one of the car and balancing weight, depending on to which direction the elevator car is meant to be moved. More particularly, on the first side of the drive wheel 6 said one or more toothed belt-shaped second ropes R are connected to the balancing weight 2 hanging therefrom, and rotation of the drive wheel 6 to first rotation direction is arranged to move said one or more toothed belt-shaped second ropes R from said first side to second side for shortening the length of said one or more toothed belt-shaped second ropes R on said first side, whereby the drive wheel 6 is arranged to pull the balancing weight 2 downwards via said one or more toothed belt-shaped second ropes R when the rope wheel 6 is rotated to first rotation, and on the second side of the drive wheel said one or more toothed belt-shaped second ropes R are connected to the car 1 and hanging therefrom, and rotation of the drive wheel to second rotation direction is arranged to move said one or more toothed belt-shaped second ropes R from said second side to first side for shortening the length of said one or more toothed belt-shaped second ropes R on said second side, whereby the drive wheel 6 is arranged to pull the car 1 downwards via said ropes R when the rope wheel 6 is rotated to second rotation.

FIG. 2 illustrates an elevator, which is otherwise similar to what was described in context of FIG. 1 but in this embodiment, there are two of each of the defined first roping, the defined first rope wheel, the defined balancing weight, the defined drive wheel rotatable with a motor, and the defined second roping. The drive wheels 6,6′, however, preferably have a common motor M for rotating both of these drive wheels 6, 6. In accordance with what is described in context of FIG. 1, also this elevator comprises an automatic elevator control 100 arranged to control the motor M, whereby rotation of the drive wheels 6,6′ and thereby also the movement of the car 1 and balancing weights 2,2′ is automatically controllable.

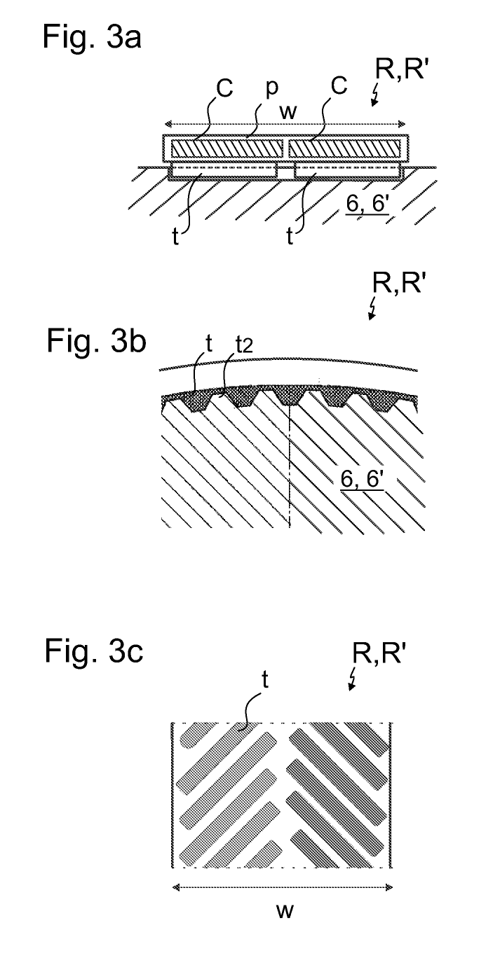

FIGS. 3a to 3c illustrate further preferred details of the second ropes R,R′ as well as the engagement between the second ropes R,R′ and the drive wheel 6. As mentioned, the second ropes R,R′ are toothed. The teeth t of the drive wheel 6,6′ and the teeth of the belt-shaped second ropes R,R′ intermesh. This is advantageous as in this way absolute traction is obtained without high rope tension. Therefore, the drive wheel 6,6′ can be arranged to affect the second roping that does not primarily serve the function of suspending the car and balancing weight. The rope R,R′ being toothed means that the rope R,R′ has numerous teeth t distributed in longitudinal direction of the rope R,R′ along the length thereof. The toothed drive wheel 6,6′, on the other hand, has correspondingly numerous teeth t2 distributed along the circumference thereof. The teeth t,t2 form ridges leaving valleys therebetween, the ridges and valleys extending at least substantially in transverse direction of the rope R,R′, and at least substantially in axial direction of the drive wheel 6,6′, respectively. The ridges and valleys may be at a straight angle relative to the longitudinal direction of the rope, but preferably they are such that they form a chevron pattern. Thus, the belt-shaped rope R,R′ is centralized on the rim of the drive wheel 6,6′. In particular, the teeth t,t2 may have the shape of a letter V or U.

The structure of the second ropes R,R′ is preferably furthermore such that the load-bearing member(s) C of each second rope R,R′ is/are embedded in a coating p made of elastomer and forming the outer surface of the rope R,R′ and having a toothed shape thereby forming teeth of the toothed belt-shaped second rope R.

It is preferable that the first and second end of each first rope r as well as the first and second end of each second rope R,R′ are fixed to the elevator car 1 and the balancing weight 2, as illustrated in FIGS. 1 and 2. In this kind of system, the first and second roping 3,5 form each part of a same closed loop, whereby their overall longitudinal stiffness is summed up, which is advantageous in terms of reversible rope elongation during elevator use.

Each of said one or more first rope wheels 4,4′ is non-driven, the first ropes r,r′ passing around non-driven rope wheels 4,4′ only. Thereby, force for moving the elevator car 1 and balancing weight 2,2′ is applied only on the second ropes R,R′.

In the elevator system presented, the structure and lateral guidance of the first ropes r,r′ can be optimized for the purpose of suspension, more specifically in terms of ability to bear the car 1 and balancing weight(s) 2,2′ on opposite sides of said one or more first rope wheels 4,4′. Further, the structure and lateral guidance of the second ropes R,R′ can be optimized for the purpose of transmitting force for motion control, more specifically in terms of ability to receive traction force from a drive wheel 6,6′ and transmitting it to the car 1 and balancing weight(s) 2,2′. It is preferable that each of said one or more first ropes r is engaged by the first wheels 4 without positive engagement for force transmission between the first wheels 4 and rope r in longitudinal direction of the rope r. In this direction, the engagement is frictional. Each of said one or more belt-shaped first ropes r,r′ is particularly preferably untoothed, i.e. without teeth distributed in longitudinal direction of the rope r along the length thereof.

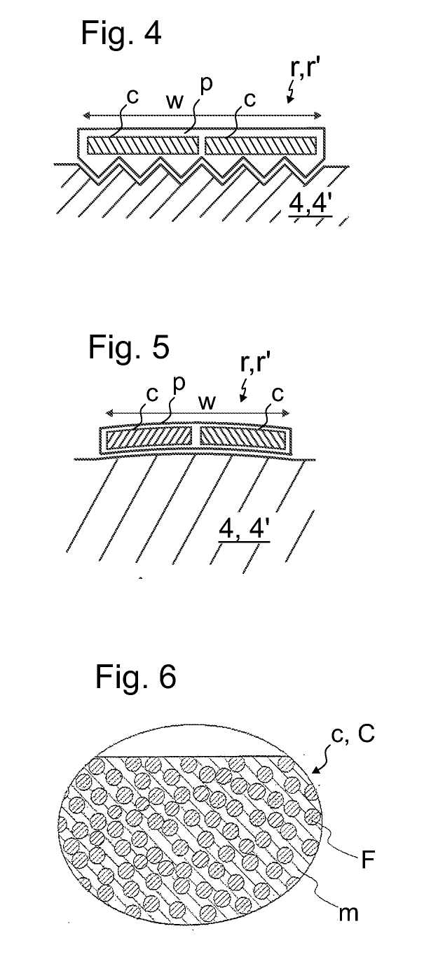

FIGS. 4 and 5 illustrate preferable alternative structures for the first ropes r,r′. In both cases, the first rope r,r′ is untoothed. Thereby, the rope structure is simple and easy to manufacture, as it can be formed to have a uniform cross section throughout its length. No teeth are needed because no traction is needed to be transmitted via the engagement between these ropes and the rope wheels around which they pass. In the alternative illustrated in FIG. 4, each of said first rope(s) r has at least one contoured side provided with guide rib(s) and guide groove(s) oriented in the longitudinal direction of the rope r,r′, said contoured side being fitted to pass against a contoured circumference of the first rope wheels 4,4′ said circumference being provided with guide rib(s) and guide groove(s) so that said contoured circumference forms a counterpart for said contoured side(s) of the rope(s) 4,4′. Thus, the rope wheels 4,4′ provide the rope r lateral guidance, however without positive engagement in longitudinal direction of the rope r,r′. In the alternative illustrated in FIG. 5, each of said first rope(s) r,r′ has a side which is smooth in longitudinal direction thereof fitted to pass against a smooth and cambered circumference of a rope wheel 4,4′ in particular such that neither of said circumference of a rope wheel 4,4′ nor the rope r,r′ has protrusions extending into recesses of the other. In this case, the rope r,r′ is so called flat rope. The cambered rope wheels 4,4′ provide the rope r,r′ lateral guidance, i.e. guidance in axial direction of the rope wheel 4,4′.

The structure of the first ropes r is preferably furthermore such that the load-bearing member(s) c of each first rope r is/are embedded in a coating p made of elastomer and forming the outer surface of the rope r,r′ and having an untoothed shape.

As mentioned, the first ropes r,r′ and second ropes R,R′ are belt-shaped, and thereby have a width w substantially larger than the thickness thereof. This makes it well suitable for elevator use as small radius bending of the rope is necessary in most elevators. Each rope r,r′,R,R′ comprises continuous load bearing members c,C extending in longitudinal direction of the rope r,r′,R,R′ throughout the length of the rope r,r′,R,R′. The number of load bearing members c,C comprised in the rope r,r′,R,R′ can alternatively be also greater or smaller than the two shown in FIGS. 3a, 4 and 5. Each of the load bearing member(s) c, C is parallel with the longitudinal direction of the rope r,r′,R,R′, whereby they are in position to provide excellent longitudinal stiffness for the rope r,r′,R,R′. The fibers F preferably are continuous fibers, in particular fibers continuous throughout the length of the load bearing member c, C and thereby also that of the rope r,r′,R,R′. So as to provide the rope r,r′,R,R′ with a turning radius well suitable for elevator use, it is preferable that the width/thickness ratio of the rope is substantially great, in particular more than 2, preferably more than 4 as illustrated. Thus, reasonable bending radius can be achieved for the rope r,r′,R,R′ even as it contains material of substantially high bending rigidity, such as the fiber reinforced composite material as described. The ropes being belt-shaped they have two oppositely facing wide sides extending in width direction of the rope (which face in FIGS. 3a, 4, 5 and 7 upwards and downwards), as well as lateral flanks (which face in said Figures left and right). Each rope r,r′,R,R′ passes around the rope wheel 4,4′,6,7,6′ the wide side of the rope r,r′,R,R′ against the rope wheel in question. There are preferably several ropes r,r′,R,R′ in each of said ropings 3,3′,5,5′, in which case the ropes r,r′,R,R′ of the same roping pass around each of said rope wheels adjacent each other in axial direction of the wheel as well as adjacent each other in the width-direction w of the ropes, the wide sides of each rope r,r′,R,R′ against the wheel in question.

As mentioned, the load bearing members c,C are preferably embedded in an elastic coating p forming the surface of the rope r,r′,R,R′ as illustrated. The coating p is preferably made of elastomer. In general, the elastic coating p provides the rope r,r′,R,R′ good wear resistance, protection, and isolates the load bearing members c,C from each other. The elastic coating p also provides the rope surface which can be molded in desired form without affecting the shape of the load bearing members c,C. The elastomer is preferably polyurethane, which provides best results in terms of traction and durability in elevator use.

As mentioned, each of said load bearing members c,C is made of composite material comprising reinforcing fibers F embedded in polymer matrix m. FIG. 6 illustrates inside the circle a partial and enlarged cross-section of the load bearing member c,C of the rope r,r′,R,R′. The material provides the rope r,r′,R,R′ excellent longitudinal stiffness and low weight, which are among preferred properties for an elevator, particularly when the fibers are of the type that will be later described.

To reduce buckling of fibers and to facilitate a small bending radius of the rope, among other things, it is preferred that the polymer matrix is hard, and in particular non-elastomeric. The most preferred materials are epoxy resin, polyester, phenolic plastic or vinyl ester. The matrix of the load bearing member c,C is preferably such that the module of elasticity E of the polymer matrix is over 2 GPa, most preferably over 2.5 GPa, yet more preferably in the range 2.5-10 GPa, most preferably of all in the range 2.5-3.5 GPa. The structure is advantageous as hereby the service life of the rope can be extended. However, should one not be concerned with possible challenges with regard to buckling, the matrix can be alternatively made of any other polymer material, such as rubber.

The composite material is preferably such that the individual reinforcing fibers F are parallel with the length direction of the rope r,r′,R,R′. The fibers F are thus substantially untwisted relative to each other. Thus, they provide excellent longitudinal stiffness for the rope. In particular, the fibers are in position where they cannot substantially straighten under tension whereby they provide a substantially stiffer structure than one produced by substantially twisting fibers or wires.

The individual reinforcing fibers are preferably distributed in the matrix substantially evenly, such that substantially all the individual reinforcing fibers of the load bearing member are bound to each other by the matrix m common to them all. The matrix m has been fixed to substantially all the individual fibers by chemical bonding. The composite load bearing member of the rope r,r′,R,R′ can be in accordance with any one of the load bearing composite members disclosed in international patent application WO2009090299A1.

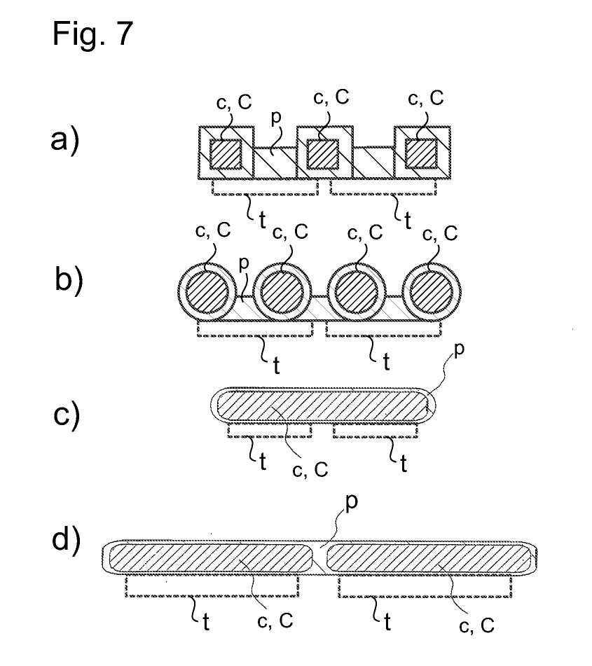

Several alternative cross-sections for the ropes r,r′,R,R′ have been illustrated in FIG. 7.

Said reinforcing fibers F of the first ropes r,r′ are preferably carbon fibers. Thus, the ropes are excellent in longitudinal stiffness and tensile strength with lightweighted structure. The elevator can thus be formed to have a high lifting height as problems concerning rope weight are eliminated. Particularly, the problem of ropes of metal materials that the rope has too low a tensile strength for it to support its own weight, is eliminated. It is important, that the material of the first ropes r is optimized in terms of their longitudinal stiffness and tensile strength without compromising in weight, because the first ropes r are the ropes which undergo greatest forces during elevator use.

Said reinforcing fibers F of the second ropes R,R′ are preferably also carbon fibers. Thus, also the second ropes R,R′ are excellent in longitudinal stiffness and tensile strength with lightweighted structure. Thereby, the elevator can be formed to have a high lifting height as problems concerning rope weight are eliminated and force transmission from the drive wheel 6,6′ to the car 1 or balancing weight(s) 2,2′ is effective. However, it is not necessary that the fibers F of the load bearing members C of the second ropes R,R′ are carbon fibers. In another preferred alternative, the fibers F of the load bearing members C of the second ropes R,R′ are nanocellulose fibers, which provide the rope relatively good longitudinal stiffness and tensile strength, however being easier to bend. Thus, radius of the drive wheel 6,6′ can be more freely chosen.

When said reinforcing fibers F of the second ropes R,R′ are different 7 than the reinforcing fibers F of the first ropes r, the properties of the first and second roping can be optimized according to their function. Then it is preferable that said reinforcing fibers F of the first ropes r,r′ are carbon fibers, and said reinforcing fibers F of the second ropes R,R′ are nanocellulose fibers.

The rope wheels are preferably mounted such that at least the toothed drive wheel 6,6′, and preferably also all of said one or more first rope wheels 6,7, is mounted inside the lower end of the hoistway H, as illustrated. However, it is possible to mount the wheel(s) 6,7,6′ alternatively inside a space formed beside or below the lower end of the hoistway H. The rope wheels are preferably furthermore mounted such that said one or more first rope wheels 4,4′ are mounted inside the upper end of the hoistway H. However, it is possible to mount the wheel(s) 4,4′ alternatively inside a space formed beside or above the upper end of the hoistway H.

As described, the elevator may include one or two balancing weights 2,2′. In case the elevator has only one balancing weight 2, it preferably alone balances all or part of the mass of the elevator car. In case the elevator has two balancing weights 2, they preferably together balance all or part of the mass of the elevator car.

It is to be understood that the above description and the accompanying Figures are only intended to illustrate the present invention. It will be apparent to a person skilled in the art that the inventive concept can be implemented in various ways. The invention and its embodiments are not limited to the examples described above but may vary within the scope of the claims.

1. An elevator, comprising:
a hoistway;
an elevator car vertically movable in the hoistway;
a balancing weight vertically movable in the hoistway;
a first roping comprising one or more belt-shaped first ropes interconnecting the elevator car and the balancing weight, each of said one or more first ropes passing around one or more first rope wheels mounted in proximity of the upper end of the hoistway, each of said one or more first ropes comprising one or more load-bearing members, each of the one or more load-bearing members being made of composite material comprising reinforcing fibers embedded in a polymer matrix;
a second roping comprising one or more toothed belt-shaped second ropes interconnecting the elevator car and the balancing weight, each of said one or more second ropes passing around one or more second rope wheels mounted in proximity of the lower end of the hoistway, each of said one or more second ropes comprising one or more load-bearing members, each of one or more load-bearing members being made of composite material comprising reinforcing fibers embedded in a polymer matrix;
said one or more second rope wheels comprising a toothed drive wheel engaging said one or more toothed belt-shaped second ropes; and
a motor for rotating the drive wheel.

2. The elevator according to claim 1, wherein on the first side of the drive wheel, said one or more toothed belt-shaped second ropes are connected to the balancing weight hanging therefrom, and rotation of the drive wheel to a first rotation direction is arranged to move said one or more toothed belt-shaped second ropes from said first side to second side for shortening a length of said one or more toothed belt-shaped second ropes on said first side, whereby the drive wheel is arranged to pull the balancing weight downwards via said one or more toothed belt-shaped second ropes when the drive wheel is rotated to said first rotation direction, and
wherein on the second side of the drive wheel said one or more toothed belt-shaped second ropes are connected to the car hanging therefrom, and rotation of the drive wheel to a second rotation direction is arranged to move said one or more toothed belt-shaped second ropes from said second side to first side for shortening a length of said one or more toothed belt-shaped second ropes on said second side, whereby the drive wheel is arranged to pull the elevator car downwards via said second toothed belt-shaped ropes when the drive wheel is rotated to said second rotation direction.

3. The elevator according to claim 1, wherein the first and second end of each first rope as well as the first and second end of each second rope are fixed to the elevator car and the balancing weight, respectively.

4. The elevator according to claim 1, wherein each of said one or more first ropes is engaged by the first wheels without positive engagement for force transmission between the first wheels and the first rope in a longitudinal direction of the rope.

5. The elevator according to claim 1, wherein each of said one or more belt-shaped first ropes is untoothed.

6. The elevator according to claim 1, wherein each of said one or more belt-shaped first ropes has a uniform cross section throughout a length thereof.

7. The elevator according to claim 1, wherein each of said one or more first rope wheels is non-driven, the first ropes passing around non-driven rope wheels only.

8. The elevator according to claim 1, wherein each of said first rope(s) has at least one contoured side provided with guide rib(s) and guide groove(s) oriented in the longitudinal direction of the rope, said contoured side being fitted to pass against a contoured circumference of the one or more first rope wheels, said circumference being provided with guide rib(s) and guide groove(s) so that said contoured circumference forms a counterpart for said contoured side(s) of the rope(s).

9. The elevator according to claim 1, wherein each of said first rope(s) has at least one smooth side fitted to pass against a cambered circumference of the one or more of the first rope wheels.

10. The elevator according to claim 1, wherein the load-bearing member(s) of each second rope is/are embedded in a coating made of elastomer and forming an outer surface of the rope and having a toothed shape.

11. The elevator according to claim 1, wherein the load-bearing member(s) of each first rope is/are embedded in a coating made of elastomer and forming an outer surface of the rope.

12. The elevator according to claim 1, wherein said reinforcing fibers of the first ropes are carbon fibers.

13. The elevator according to claim 1, wherein said reinforcing fibers of the second ropes are carbon fibers.

14. The elevator according to claim 1, wherein said reinforcing fibers of the second ropes are different fibers than the reinforcing fibers of the first ropes.

15. The elevator according to claim 1, wherein the individual reinforcing fibers in the one or more first ropes and the one or more second ropes are parallel with a length direction of the first and second ropes.

16. The elevator according to claim 14, wherein said reinforcing fibers of the first ropes are carbon fibers, and said reinforcing fibers of the second ropes are nanocellulose fibers.

17. The elevator according to claim 2, wherein the first and second end of each first rope as well as the first and second end of each second rope are fixed to the elevator car and the balancing weight, respectively.

18. The elevator according to claim 2, wherein each of said one or more first ropes is engaged by the first wheels without positive engagement for force transmission between the first wheels and the first rope in a longitudinal direction of the rope.

19. The elevator according to claim 3, wherein each of said one or more first ropes is engaged by the first wheels without positive engagement for force transmission between the first wheels and the first rope in a longitudinal direction of the rope.

20. The elevator according to claim 2, wherein each of said one or more belt-shaped first ropes is untoothed.
